(19) United States
(12) Patent Application Publication
(10) Pub. No.: US 2018/0264399 A1
(43) Pub. Date: Sep. 20, 2018

(54) MEMBRANE CONTACTOR COMPRISING A COMPOSITE MEMBRANE OF A POROUS LAYER AND A NON-POROUS SELECTIVE POLYMER LAYER FOR CO2 SEPARATION FROM A MIXED GASEOUS FEED STREAM

(71) Applicant: NORWEGIAN UNIVERSITY OF SCIENCE AND TECHNOLOGY (NTNU), Trondheim (NO)

(72) Inventors: Liyuan Deng, Trondheim (NO); Luca Ansaloni, Trondheim (NO); May-Britt Hägg, Trondheim (NO); Hallvard Fjøsne Svendsen, Trondheim (NO); Hanna Knuutila, Trondheim (NO)

(21) Appl. No.: 15/762,830

(22) PCT Filed: Sep. 30, 2016
(86) PCT No.: PCT/EP2016/073522

§ 371 Date: Mar. 23, 2018

(30) Foreign Application Priority Data
Sep. 30, 2015 (GB) 1517272.9

(51) Int. Cl. B01D 53/22; B01D 69/08; B01D 71/36; B01D 69/14; B01D 71/02; B01D 53/14; C10L 3/10

(52) U.S. Cl. CPC B01D 53/228; B01D 53/229; B01D 69/08; B01D 71/36; B01D 69/148; B01D 71/028; C10L 2290/548; B01D 53/1475; C10L 3/104; B01D 2053/224; B01D 2252/20484; B01D 2252/2041; B01D 53/1493

(57) ABSTRACT

A membrane contactor system for separating CO₂ from a mixed gaseous feed stream comprising CO₂, said contactor system comprising: (i) a composite membrane, said membrane having a permeate side and a retentate side; (ii) said retentate side being exposed to a mixed gaseous feed stream comprising carbon dioxide; (iii) said permeate side being exposed to a carbon dioxide capture organic solvent; (iv) said composite membrane comprising a porous layer and a non-porous selective polymer layer, said non-porous selective polymer layer selectively allowing transport of CO₂ across the composite membrane from said mixed gaseous feed stream so that it dissolves in said capture solvent whilst limiting the transport of said capture solvent across the composite membrane.

This invention relates to the use of a composite membrane in a membrane contactor for separating CO₂ from a gas mixture comprising CO₂ using 3^{rd} generation organic capture solvents (including, for example, phase change solvents and absorbents with high volatility). In particular, the composite membrane is obtained by coating a porous support with a non-porous, chemically stable and selective polymeric layer, which allows transport of CO₂ across the composite membrane and into a CO₂ capture solvent, but essentially prevents transport of the CO₂ capture solvent, typically a volatile organic nitrogen containing solvent, into the gas phase. The invention also relates to a process for selectively separating CO₂ from a mixed gaseous feed stream comprising CO₂ using said composite membrane.

### BACKGROUND OF THE INVENTION

Combustion of fossil fuels has met the ever growing energy demand but it has resulted in unchecked levels of CO₂ emission. These carbon dioxide emissions are considered to be a major culprit in global warming and climate change. Carbon capturing technologies vary significantly depending on point source due to the great diversity in pressure, temperature and composition of sour gas streams. Several technologies have been investigated for CO₂ capture but high capital investment and operational costs are major hindrances in their large scale industrial application.

One solution for carbon capture utilizes solvents. Amine-based solvent scrubbing is the only process technology currently available at a scale approaching the scale needed for flue gas CO₂ capture from power plants. However, a high energy load is associated with the use of traditional solvent scrubbing processes, as the scrubbing solvent must be regenerated.

Conventionally, solvent and gas contact takes place in an absorption tower, in which there is no physical boundary between gas and liquid and all volatile components can freely move between the phases. In one way this is an advantage as there is no resistance at the interface between the components apart from what is created inside the gas and liquid phases. On the other hand volatile compounds like solvent molecules and degradation products are not restricted either, and in addition, physical interaction may give rise to droplets (i.e., aerosol and mist), which, if small enough, can be carried along with the gas.

So called “3^{rd} generation” CO₂ capture solvents, which have been demonstrated to have a large potential with regard to regeneration energy savings, are quite volatile and this is possibly the major obstacle to their use industrially. Indeed, when it comes to their gas phase concentration, the high volatility will necessitate extended and more comprehensive water washing. In some cases a pure water wash may not be enough and an acid wash is added, which inevitably will lead to solvent loss and extra costs. In cases where the gas to be treated contains particles or other precursors to possible aerosol/mist formation, e.g. SO₃, then solvent and degradation product volatility will be a decisive factor in the formation of mists with organic content. In this view, absorption towers do not represent the most suitable technology to exploit the 3^{rd} generation solvent potential and a new approach is required to make their use more “environmentally friendly” on an industrial scale.

Membrane-based gas separation technology may overcome the regeneration energy penalty noted above for solvent-based processes, but is not as well-established. Membrane solutions rely on a selective polymer layer to remove CO₂ from a gas containing CO₂. For flue gas carbon capture applications in power plants, membrane-based CO₂ capture processes also require considerable energy input because flue gas typically needs to be compressed to a high pressure prior to being passed through the membrane.

The present inventors seek to use a combination of membrane and solvent technologies. Some technologies combining these two acid gas removal technologies (solvent-based and membrane-based) have previously been developed.

Membrane contactors have been suggested as an alternative to ordinary absorption towers as gas/liquid contactors because of their possibility for high specific contact areas, small footprint, possible lower cost and operational advantages as e.g. insensitivity to gas/liquid volumetric flow ratio. The objective of the membrane is to provide a non-selective physical barrier between gas and liquid, avoiding bubbling of the gas through the liquid, but at the same time reducing as much as possible the additional mass transfer resistance for the CO₂ transport into the liquid phase. Non-selective, highly porous hydrophobic membranes are most often used in membrane contactors as barrier between gas and aqueous solvent. They allow all gas components to travel freely through the membrane and all selectivity is provided by the liquid phase. This works well for solvent systems being selective to CO₂, such as amines, amino acids and carbonate systems, with a low concentration of the organic compounds.

In US20130319231 an integrated membrane system is described in which separation is based on the selectivity of a dense membrane for CO₂ over N₂.

The present inventors are looking to prepare a 3^{rd} generation solvent membrane reactor with low energy requirements, in particular with lower energy needs for regeneration in a reboiler. The invention addresses concerns with aerosol and mists associated with high volatility solvents. Mists and aerosols can be avoided even though the entering gas can contain nucleation molecules, such as SO₃.

In view of the above-mentioned challenges, it is an object of the present invention to develop a new composite membrane contactor for CO₂ separation. The membrane in this membrane contactor is designed to allow CO₂ transport but specifically to prevent or minimise solvent transport, i.e. a membrane with high CO2/solvent selectivity. By designing the composite membrane in this fashion, it actually becomes irrelevant whether the membrane offers high separation efficiency of CO₂ from the other inert components in the feed stream, such as N₂. These compounds may pass through the composite membrane and then back through the membrane to the gas mixture so as to establish an equilibrium between the two sides of the composite membrane. Ideally, the membrane should have high CO₂ permeability to help maximise efficiency. The membrane also works in an aqueous environment and has long term stability towards organic solvents.

It has surprisingly been found that this may be achieved in a system comprising a non-porous composite membrane comprising a dense, solvent selective, membrane layer comprising a polymer and a porous support layer separating a carbon dioxide containing gas and a solvent for CO₂ capture.

### SUMMARY OF THE INVENTION

Thus, viewed from one aspect, the invention provides a membrane contactor system for separating CO₂ from a mixed gaseous feed stream comprising CO₂, said contactor comprising:
(i) a composite membrane, said membrane having a permeate side and a retenate side;
(ii) said retenate side being in contact with a mixed gaseous feed stream comprising carbon dioxide;
(iii) said permeate side being in contact with a carbon dioxide capture organic solvent;
(iv) said composite membrane comprising a porous layer and a non-porous selective polymer layer, said non-porous selective polymer layer selectively allowing transport of CO₂ across the composite membrane from said mixed gaseous feed stream so that it dissolves in said capture organic solvent whilst limiting the transport of said capture organic solvent across the composite membrane.

In operation, therefore carbon dioxide passes from said mixed gaseous feed stream through the composite membrane and is dissolved in the solvent. Said non-porous selective polymer layer is impermeable or of limited permeability to said solvent so limits capture solvent transfer across the membrane from permeate to retentate side. The solvent containing dissolved carbon dioxide can be removed, CO₂ removed from the solvent and lean solvent returned to the process to ensure efficient CO₂ removal from the mixed gaseous feed stream.

Viewed from another aspect, the invention provides a membrane contactor system for separating CO₂ from a mixed gaseous feed stream comprising CO₂, said contactor comprising:
(i) a composite membrane, said membrane having a permeate side and a retenate side;
(ii) said retenate side being exposed to a mixed gaseous feed stream comprising carbon dioxide;
(iii) said permeate side being exposed to a carbon dioxide capture organic solvent;
(iv) said composite membrane comprising a porous layer nearest the retentate side of the membrane and a non-porous selective polymer layer nearest the permeate side of the membrane, said non-porous selective polymer layer selectively allowing transport of CO₂ across the composite membrane from said mixed gaseous feed stream so that it dissolves in said capture solvent whilst limiting the transport of said capture solvent across the membrane.

Viewed from a further aspect, the invention provides a process for separating CO₂ from a mixed gaseous feed stream containing CO₂, said process comprising contacting said mixed gaseous feed stream with a composite membrane comprising a non-porous, selective polymer layer for separating CO₂ from a mixed gaseous feed stream, said layer being carried on a porous support layer:

allowing CO₂ to pass through said porous support layer and said non-porous selective polymer layer to make contact with an organic capture solvent which dissolves said CO₂; wherein

said non porous, selective polymer layer is impermeable or of limited permeability to said capture solvent.

Viewed from a further aspect, the invention provides the use of a composite membrane together with organic capture solvents as hereinbefore defined in a process for separating CO₂ from a mixed gaseous feed stream containing CO₂.

Viewed from a further aspect, the invention provides a process for separating CO₂ from a mixed gaseous feed stream containing CO₂, said process comprising contacting said mixed gaseous feed stream with a composite membrane

said membrane having a permeate side and a retentate side;

said retentate side being exposed to said mixed gaseous feed stream comprising carbon dioxide;

said permeate side being exposed to a carbon dioxide capture organic solvent;

said composite membrane comprising a porous layer nearest the retentate side of the membrane and a non-porous selective polymer layer nearest the permeate side of the membrane,

wherein CO₂ is transported across the composite membrane from said mixed gaseous feed stream and dissolves in said capture solvent.

In a preferred process, capture solvent in which carbon dioxide is dissolved is removed from the permeate side of the contactor and lean solvent is regenerated by removing said dissolved carbon dioxide therefrom. Lean solvent can then be recycled for further carbon dioxide capture.

The organic capture solvent is ideally a 3^{rd} generation organic capture solvent.

### Definitions

The non porous selective polymer layer is selective for carbon dioxide over capture solvent. That means that the composite membrane allows the transport of carbon dioxide but limits the transport of capture solvent. By limits the transport of capture solvent is meant that the transport of carbon dioxide is at least 10× higher than the transport of solvent, such as at least 50× higher especially at least 100×.

### DETAILED DESCRIPTION OF THE INVENTION

The present invention concerns a process for separating carbon dioxide from a gaseous feed stream containing carbon dioxide using a composite membrane in conjunction with a CO₂ capture solvent, typically a 3^{rd} generation capture solvent. It will be appreciated that the mixed gaseous feed stream must contain CO₂ and at least one other gas component. The composite membrane comprises a dense or non porous (these terms are used interchangeably herein), selective layer coated on a porous support layer. The selective layer comprises a polymer, a mixture of polymers or a mixture of at least one polymer and an inorganic phase embedded within the polymer matrix that is non-porous but is selective for CO₂.

In operation, the porous support layer is ideally adjacent the gaseous feed (the retentate side of the membrane) and the non-porous selective layer is adjacent the solvent (the permeate side of the membrane).

### Gaseous Feed Stream

The mixed gaseous feed stream used in the process of the invention may be any gas stream comprising a mixture of at least two gases, wherein one of these gases is CO₂. The use of flue gas or biogas is especially preferred.

In a preferred embodiment, the feed stream comprises (e.g. consists of) nitrogen (N₂) and CO₂. In an alternative preferred embodiment, the feed stream comprises (e.g. consists of) methane (CH₄) and CO₂. In a further alternative embodiment, the feed stream comprises (e.g. consists of) hydrogen (H₂) and CO₂.

The feed stream may comprise 1 to 90 vol %, preferably 2 to 85 vol %, more preferably 5-60 vol %, such as 10-50 vol % CO₂ relative to the total amount of gas present.

In one particular preferred embodiment, the feed stream comprises 4 to 50 vol % CO₂ relative to the total amount of gas present (e.g. when the feed stream comprises natural gas, flue gas or biogas).

It will be appreciated that in addition to the gases mentioned above, the gaseous feed stream may comprise further gases. Examples of such further gases include hydrogen, methane, nitrogen, NOx, carbon monoxide, hydrogen sulphide, hydrogen chloride, hydrogen fluoride, sulphur dioxide, carbonyl sulphide, ammonia, oxygen and heavy hydrocarbons such as hexane, octane or decane.

In a particularly preferred embodiment, the gaseous feed stream may comprise flue gas from power plants or other industrial sources, such as cement and steel manufacturers. It will be understood that by “flue gas” we mean a mixture comprising nitrogen, NOx and sulfur dioxide in addition to carbon dioxide and other optional gases such as oxygen.

In a particularly preferred embodiment, the gaseous feed stream may comprise syngas, most preferably pre-combustion syngas, i.e. syngas which has yet to be combusted for power production. It will be understood that by “syngas” we mean a mixture comprising hydrogen and carbon monoxide in addition to carbon dioxide and other optional gases such as hydrogen sulfide.

Alternatively, in a further preferred embodiment, the gaseous feed stream may comprise biogas or natural gas, i.e. a mixture of gases comprising methane and carbon dioxide in addition to other optional gases such as hydrogen sulphide and carbon monoxide.

When the gaseous feed stream comprises biogas or natural gas, the process of the invention is primarily used to separate CO₂ from CH₄. Natural gas is a combustible mixture formed primarily of methane, but it can also include sour gas carbon dioxide and hydrogen sulphide. The composition of natural gas can vary widely, but typically contains methane (70-90 vol %), ethane/butane (0-20 vol %), nitrogen (0-5 vol %) carbon dioxide (0-12 vol %) and hydrogen sulphide (0-5 vol %) before it is refined. CO₂ in natural gas should ideally be removed (natural gas sweetening) to meet specifications in order to increase heating value (Wobbe index) and reduce corrosion of pipelines. Ideally, the CO₂ content should be reduced to <2 vol %.

Biogas is a mixture of gases generated from anaerobic microbial digestion from organic wastes such as manure, landfill or sewage. The composition of biogas varies depending on the source. Typically biogas contains 60-65 vol % CH₄, 35-40 vol % CO₂, small amounts of hydrogen sulfide (H₂S), water vapour and traces of other gases. Depending on the source, nitrogen (N₂) may be present. The removal of carbon dioxide (CO₂) from biogas to a level of methane (CH₄)>90 vol %, termed “upgrading”, can not only effectively increase the Wobbe index, but also reduce corrosion caused by acid gas and therefore extend the biogas utilization as a renewable energy resource. Upgraded biogas containing at least 98 vol % of CH₄ may be compressed and liquefied for vehicle fuel or injected into a public natural gas grid.

### Solvent

The solvent used in the invention is one that dissolves CO₂ and that ideally cannot pass through the composite membrane or passes only to a limited extent compared to CO₂ through the composite membrane. It must also be inert/compatible with the materials in the selective layer and porous layer. It should be a liquid solvent at the operation conditions of the process.

The solvent is organic although it can be mixed with water as discussed below. What is critical is that the membrane resists transport of the organic part of the capture solvent. The solvent must be one that dissolves CO₂ reversibly.

In this case, the term dissolution means that the solvent interacts with CO₂ (e.g. by chemical reaction, chemical or physical absorption) in a manner that CO₂ is preferentially taken up by the liquid phase and remains in the liquid phase.

The solvent may solubilize CO₂ by any means, e.g. the CO₂ may be soluble in the solvent or the CO₂ may react with a dissolved species or the solvent itself to form a soluble species. Non-limiting examples of some types of solvents that are encompassed within the present invention include solutions comprising one or more amines (including alkanolamines), amino acids, organic carbonates and amine based ionic liquids.

Because the system may be designed such that oxygen that may be in the mixed gas stream does not come in direct contact with the liquid phase, solvents that typically degrade in and thus cannot be used in oxygen-containing gas streams may be used in certain embodiments of the present invention.

If the oxygen concentration is very low, then the membrane can prevent the solvent being oxidized. The presence of the composite membrane can therefore limit the oxidation of the solvent.

Mixtures of solvents may also be used according to the present invention.

The solvent of use in the invention is one that dissolves carbon dioxide reversibly ideally with high equilibrium temperature selectivity. It is important that the solvent can be regenerated so it should be easy to remove the CO₂ from the solvent and return the lean solvent to the process. The term lean solvent is used herein to refer to the solvent essentially without CO₂ dissolved therein. Rich solvent will be used to define solvent in which CO₂ is dissolved.

Preferred solvents are solvents based on a mixture of an organic base and an amine, solvents based on a combination of amines or simply amine functionalised ionic liquids. Some preferred solvents undergo demixing (i.e. solvents that form two phases) when mixed with CO₂.

Thus the solvent is preferably one that comprises nitrogen atoms. Solvents based on the atoms C, H, N and O only are especially preferred. The solvent is preferably a solvent of low molecular weight (MW), i.e. no component of the solvent preferably has an MW of 400 g/mol or more. Ideally components of the solvent have a MW of 200 g/mol or less.

Preferably a mixture of two amines is used as the solvent such as the blend of a primary amine and a secondary or tertiary amine. In some embodiments, secondary amines are avoided (as the presence of oxygen in the gaseous feed can allow nitrosamine to form) but if oxygen can be avoided in the solvent as discussed above, secondary amines are a suitable solvent.

A further solvent combination of interest uses an organic base plus an amine. Organic bases of interest are weak bases such as those based on nitrogen heterocycles, e.g. pyridine, imidiazoles, benzimidazole etc.

Further solvent combinations include amino acids (neutralised) combined with amines. Amine functionalised ionic liquids include imidazole based compounds. The skilled person is generally familiar with carbon dioxide capture solvents. Preferred solvents comprise both nitrogen and —OH.

In a preferred embodiment, the solvent comprises diethylethanolamine (DEEA). In a preferred embodiment the solvent comprises 2-aminoethanol. In a further preferred embodiment the solvent comprises N-methyl-1,3-propanediamine (MAPA). In a further preferred embodiment the solvent comprises blends of these amines.

It will be appreciated that any solvent of use in the invention may additionally contain water. The non-porous selective layer may or may not be permeable to water. That is not relevant as the gas mixture being separated may contain water as well. Our system tolerates water in all parts. Free movement of water through the membrane is acceptable.

Whilst the use of single phase solvent is envisaged, in a preferred embodiment, the solvent is one that forms a homogeneous blend on mixing but which phase separates on CO₂ capture. The CO₂ containing phase tends to be the lower phase in the demixed solvent. The theory is that the lighter solvent phase is needed to enhance absorption of CO₂ into the heavier phase. Once phase separation has occurred then only the heavier lower phase needs to be stripped and recycled thus saving on the amount of solvent that is sent to the stripper.

It may be that the heavier phase forms the major part of the solvent blend, e.g. at least 60 wt % of the solvent blend, e.g. up to 90 wt % of the solvent. It will also be appreciated that the demixing does not necessarily lead to a perfect phase separation so there will still be some content of each solvent in each phase. What occurs however is a discernible phase separation making extraction of the phases simple using conventional phase separation techniques. The use of DEEA and MAPA is preferred in this regard. DEEA and MAPA are examples of solvents that will form two phases.

The inventors have thus developed a promising third generation solvent where two liquid phases are formed during CO₂ absorption. The system is based on high concentrations of two amines, MAPA and DEEA in water. Based on the pilot campaign the required reboiler duty of this new system is low. The present invention has the potential to deliver energy numbers below 2 MJ steam/kg CO₂.

The reboiler duty refers to the energy required to regenerate lean solvent after rich solvent formation via CO₂ capture. Lower reboiler duties (i.e. the heat required to release the CO₂ from the solvent) mean a more economic process.

Another problem receiving recent strong attention for all types of solvents is the possibility of excessive solvent losses through mist/aerosol formation when treating gases containing particulates or SO₃. The present invention avoids the issues of mist formation as even if a solvent has a potential of mist formation, it cannot penetrate the dense membrane. It cannot therefore enter the gas stream and there is no risk of unwanted components entering the gas stream.

Many of the solvents have other properties that in a normal process would be considered a disadvantage, such as increased volatility and two-phase formation. Novel solvents with high energy potential but where volatility issues exist come from different classes like modified imidazoles, amine solvents forming single liquid phase amine solvents, biphasic or liquid/liquid solvents. Examples of useful solvents include:

DEEA (diethylethanolamine),

MAPA (N-methyl-1,3-propane diamine),

MEA (2-aminoethanol),

AMP (2-amino-2-methyl-1-propanol),

DMMEA (2-dimethylaminoethanol),

modified imidazoles,

12HE-PP (1-(2-Hydroxyethyl)piperidine)

DEA-12PD (3-(Diethylamino)-1,2-propanediol)

DEA-EO (2-[2-(Diethylamino)ethoxy]ethanol)

AMPD (2-Amino-2-methyl-1,3-propanediol)

AHPD (2-amino-2-hydroxymethyl-1,3-propanediol)

AEPD (2-Amino-2-ethyl-1,3-propanediol)

FIGS. 12 to 14 summarise the carbon dioxide capacity per cycle for blends of MAPA with various solvents. The solvent blends of these figures are of interest in the invention.

### Composite Membrane

The composite membranes of the invention are selective barriers which have a retentate side and a permeate side. The “retentate” side comprises those components of the gas feed stream which have not passed through the composite membrane and the “permeate” side comprises those components of the gas feed stream which have passed through the composite membrane and hence into the solvent. The composite membrane is formed from a dense, selective layer carried or coated on a support layer which is essential porous. The term dense is used here to imply that the membrane is not porous so the terms dense and non-porous are used interchangeably herein. The dense layer provides a barrier to the transport of gases and liquids.

The term selective is used to imply that the membrane allows transport of CO₂ (and potentially other gaseous components of the feed stream) whereas the transport of the organic part of the solvent through the membrane towards the gas phase is significantly hindered or prevented. If the solvent comprises water, water may pass through the membrane.

The composite membranes of the invention may be described as a composite membrane with a non-porous or dense selective layer coated on a preferably asymmetric porous support.

### Non Porous, Selective Layer

The selective layer in the composite membrane of the invention can be regarded as a dense layer. It is not porous. It allows carbon dioxide to pass through and may allow other inert components of the gas stream to pass, such as nitrogen. The membrane will be impermeable or less permeable to hydrocarbons such as methane. Ideally, the membrane is impermeable or less permeable to noxious gases such as NOx or sulphurous gases. It will be appreciated that ideally the selective layer is impermeable to hydrocarbons and noxious gases but in reality a degree of permeability is possible. The permeability to carbon dioxide should be at least 10 times that of hydrocarbons, such as at least 100×. The permeability to carbon dioxide should be at least 10 times that of noxious gases, such as at least 100×. In general, the permeability of the membrane to carbon dioxide should be at least 100× more than the permeability to whatever the CO₂ is being separated from.

The mechanism of transport of the CO₂ is not important but we perceive that CO₂ effectively “dissolves” in the dense membrane, as it is a non ideal gas, and diffuses across the dense layer. As there is a concentration gradient between gas stream and solvent, this allows the CO₂ to pass through the membrane. The concentration gradient for CO₂ transport is maintained as the solvent is removed and regenerated from the permeate side of the membrane.

Without wishing to be limited by theory, the lower solubility and larger kinetic diameters make nitrogen typically less permeable than CO₂ across the dense membrane, although there are no issues if it does pass as it is not generally soluble in the solvent. Other gases such as SO₂ and NOx may not pass through the dense layer or pass to a much lesser degree. That is important as a major problem with carbon dioxide solvents is that other components of a CO₂ containing gas such as sulphur gases and NOx cause foaming of the solvent.

It is crucial that the dense layer is chemically stable and presents a reduced or limited permeability to the solvent. Again, it will be appreciated that ideally the selective layer should be impermeable to the solvent. In reality however, some solvent might still pas through the selective layer. It should be that the transport of CO₂ is at least 100× that of the solvent, especially at least 200 times, more especially at least 500×.

Many materials conventionally used as CO₂ separating membranes cannot be used in this invention as they are incompatible with the solvent. They might be dissolved or unacceptably swollen by the solvent.

The inventors have found therefore that a dense membrane material which allows CO₂ transport but is essentially impermeable to the solvent, and is not damaged in some way by the solvent is a fluoropolymer, in view of the large strength of the C—F bond. By fluoropolymer is meant a polymer in which at least one monomer residue of the polymerising monomer(s) is fluorinated, preferably perfluorinated. The polymer might be a homopolymer of fluorinated monomers or a copolymer in which one or more fluorinated monomers is employed optionally along with other non-fluorinated residues. Ideally, the selective layer should operate to achieve high CO₂/solvent selectivity at 40 to 60° C.

The use of fluorinated monomers is preferred in the manufacture of the non porous polymer, such as perfluorinated monomers. Such a monomer might therefore be a tetrafluoroethylene. A residue is deemed perfluorinated when all bonds that would conventionally be C—H bonds are C—F. The monomer residues can contain other atoms and functional groups as well as long as C—H bonds are converted to C—F.

The fluoropolymer of the invention can be a homopolymer but is preferably a copolymer with at least one, preferably one, other comonomer. If the polymer is a copolymer, it is also preferred that the second monomer is fluorinated. The use of two or more perfluorinated monomers is especially preferred.

Monomers of interest include those used to make commercial products such as Teflon AF2400, Teflon AF1600, Hyflon AD 60, Hyflon AD 80 and Cytop as depicted below:

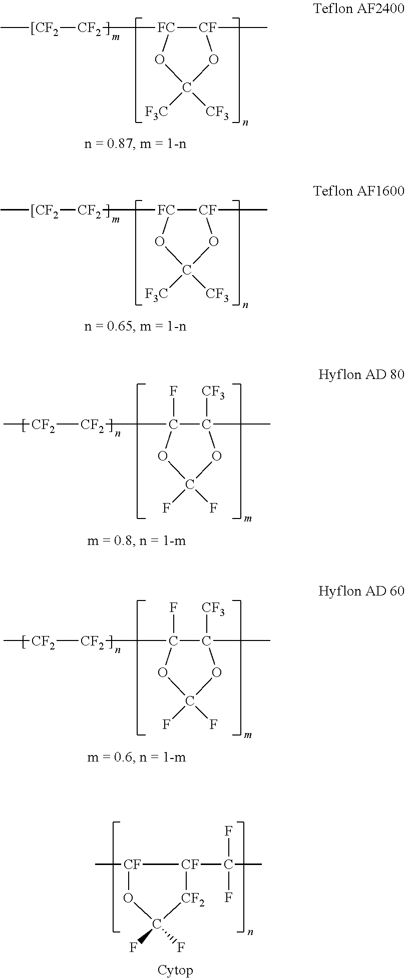

It will be appreciated that blends of different polymers can be used in the dense selective layer.

It is preferred if the dense layer polymer is a fluorinated copolymer, The use of a copolymer of fluorocarbon monomers is most preferred, in particular a copolymer of tetrafluoroethylene in which the other comonomer present is also fluorinated.

Preferred monomer residues which may be combined or used as homopolymers or copolymers are therefore the residues of tetrafluoroethylene, the five membered ring depicted above as part of Cytop, Hyflon AD80, and Teflon 2400 or the repeating unit of Cytop above.

In one embodiment, the dense layer comprises at least one polymeric component and an inorganic component. That inorganic component is preferably a nanoparticulate component or other nanostructure. It is envisaged that the inorganic component such as nanoparticles, act as a kind of dispersed phase within the organic polymer matrix.

Hybrid membranes obtained by mixing the aforementioned polymeric materials and nanoparticles or other nanostructures can therefore be used as dense selective layer. This results therefore in a hybrid organic/inorganic dense layer.

The inorganic component can be permeable or impermeable to carbon dioxide.

A preferred polymer in this embodiment is a fluoropolymer as hereinbefore defined.

It is preferred if the inorganic component is a nanoparticle or 2D nanostructure such as graphene or a derivative thereof. The nanoparticles are preferably permeable to carbon dioxide. A preferred material for such nanoparticles is an aluminium silicate.

In case of permeable nanoparticles, preferred are ones that are able to offer certain CO₂/solvent selectivity, in view of the size of the cavities characterizing the nanoparticle morphology. If the cavity size is in between the CO₂ and the amine kinetic dimension, the nanoparticles are able to improve significantly the membrane selectivity. Several zeolite and Metal Organic Frameworks (MOFs) have this feature. The inventors have, for example, successfully synthesized a dense selective layer made of Teflon AF2400 and a commercial zeolitic imidazolium framework (ZIF-8, known with the commercial name of Basolite Z1200).

Metal-organic frameworks (MOFs) are compounds consisting of metal ions or clusters coordinated to organic ligands to form one-, two-, or three-dimensional structures. They are a subclass of coordination polymers, with the special feature that they are often porous. The organic ligands included are sometimes referred to as “struts”, one example being 1,4-benzenedicarboxylic acid (BDC).

More formally, a metal-organic framework is a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions; and finally a coordination polymer is a coordination compound with repeating coordination entities extending in one, two, or three dimensions.

In case of a non-permeable inorganic phase, preferred are 2D materials (Graphene and derivatives), which have the ability to increase the diffusive pathways of the penetrants, affecting the ones with the larger kinetic size to a higher extent. In this way, better CO₂/solvent selectivity should be achieved. The inventors have, for example, successfully synthesized a dense selective layer made of Teflon AF2400 and a commercial reduced graphene oxide (XT-RGO).

Viewed from another aspect therefore, the non-porous selective polymer layer comprises at least one polymer, such as a fluoropolymer and an inorganic component such as a nanoparticle or 2d nanostructure. A preferred nanoparticle is a zeolite or metal organic framework.

Viewed from another aspect, the non-porous selective polymer layer comprises at least one polymer, such as a fluoropolymer and a nanostructure such as graphene or a derivative thereof such as graphene oxide.

The term nanoparticle refers to a particle with a diameter of less than 1 micron, such as up to 800 nm, e.g. 100 to 700 nm.

In a non porous layer of the invention, the inorganic component will preferably form no more than 20 wt % of the weight of the layer, such as 1.0 to 15 wt %, e.g. 2.0 to 10 wt % of the layer.

The thickness of the selective membrane layer is preferably in the range of less than 5 μm, preferably less than 2 μm, such as 1 μm or less. The layer may be at least 0.10 μm in thickness such as at least 0.25 μm in thickness.

A highly preferred layer thickness is 0.5 to 10 microns, depending on the polymer CO₂ permeability, as the dense layer design aims to reduce as much as possible the additional mass transfer resistance of the CO₂.

The weight average molecular weight of the polymer is preferably in the range 10,000 to 500,000, such as 40,000 to 200,000. Ideally, the MW of the polymer is higher than the molecular weight cut off (MWCO) of support substrate.

A potential issue with the polymer of the dense layer is aging, especially in case of thin films, which normally are needed to achieve the suitable CO₂ permeance through the membrane. It will be appreciated that any loss of performance over time, i.e. reduction in CO₂ transport, limits the usefulness of any polymer. The inventors have found in particular that Teflon AF polymers (i.e. AF 2400 and AF 1600) are subjected to a reduced aging phenomenon if compared to other polymers typically use in gas separation membranes, such as polyimide, polysulfone, polymer of intrinsic microporosity (PIM) and PTMSP.

A potential concern with any dense layer is uptake of solvent and hence swelling of the dense layer. Teflon AF2400 showed a rather limited solvent uptake. This is the most preferred polymer of use in the invention.

The interfacial area of the dense layer may be 500 to 1500 m²/m³.

The CO₂ permeability of the dense layer may be at least 100-1000 barrer, such as at least 3000 barrer, depending on the coating thickness.

Porous Support Layer

The selective layer of the invention is carried or coated on a porous support. The combination of the selective membrane layer and the porous support may be termed “composite membrane”.

Suitable porous supports are known in the art and are ones which are porous to the gas being transported and which are compatible with the dense layer and compatible with the solvent. Typical supports are made of polymers including PVDF, polytetrafluoroethylene and polypropylene. Some other common supports such as those based on polysulfone and polyester are unsuitable in this invention as these are dissolved by the solvent or at least undergo unacceptable levels of swelling in the presence of the solvent. Ideally, however there is no direct contact between the porous support and the solvent. The support may be in the form of a flat sheet membrane or hollow fibre membrane. In a flat sheet support, a non-woven layer is commonly used to provide mechanical strength.

In all embodiments, it is preferred if the porous support layer has a thickness of less than 500 μm, preferably less than 300 μm, more preferably 200 μm or less, such as 50-200 μm, more preferably 100 to 200 microns. The porous layer should provide as little resistance as possible to CO₂ transport. The support is really just a mechanic support.

Typically, the porous support will be asymmetric, i.e. the pores vary in size across the support, typically graduating from smaller pores at the side of porous support closest to the selective membrane layer to larger pores at the side of porous support furthest from the membrane layer. It is also possible however, e.g. in case of the PP hollow fibers, that a support with a certain average porosity is employed with a pore size that is homogeneous.

The molecular weight cut off (MWCO) of the porous support may be more than 50,000 or less, preferably 25,000 or less, more preferably 30,000 or less. The MWCO may be as low as 2000 (40 nm), preferably at least 5000.

MWCO is essentially a measure of the pore size of the support, with larger MWCO values representing higher pore sizes. By MWCO we mean the molecular weight of the components which are substantially (i.e. at least 90%) retained on the retentate side of the composite membrane and are prevented from passage through the porous support.

Manufacture

Coating of the dense layer onto a support can be achieved using solution casting, then evaporation of the solvent. Spray coating or dip coating are alternative methods for forming a dense layer on the porous support.

Preferred methods involve casting a solution of the selective layer components onto the support or immersion of the support in such a solution. The method used may be dependent upon the form of the composite membrane. The selective layer is typically cast on to the support using a coating process. Such processes are well known in the art and can include processes such as solution casting, dip-coating and spray-coating. Alternatively it can be made by interfacial polymerization or in-situ polymerization, or any other phase inversion method.

### Contactor/System Set Up

The composite membrane is preferably set up as a hollow fiber membrane. The hollow fibres define an essentially cylindrical core area separated from the area outside the core by the composite membrane. Solvent is allowed to pass down the central channel of the hollow fiber with carbon dioxide containing gas passing outside the hollow fibre (or vice versa). The hollow fibre walls are formed by the porous support layer carrying the selective layer. The selective layer is nearest the solvent side of the contactor with porous layer nearest the gas side. In operation, carbon dioxide is extracted from the gas into the solvent through the hollow fibre wall. Extraction typically takes place at low temperature—such as less than 80° C., preferably 40 to 50° C. The solvent can be heated or cooled as desired to achieve the right temperature of the solvent to maximise its ability to absorb CO₂.

Once CO₂ has been absorbed by the solvent, solvent can be removed to a stripper where temperature is increased and the CO₂ released from the solvent. In order to maximise performance, the solvent and gas can flow in opposite directions.

It is envisaged that the regeneration temperature and heat requirement for release of the CO₂ is very low. This reduces the energy required to heat the solvent in the stripper (i.e. the reboiler energy requirement).

Flue gas contains sulphurous compounds which can dissolve in the solvent causing mists. This is a problem with any organic solvent with a vapour pressure. As the solvent is preferably not adjacent the porous support, there is also no issue with pore wetting/bubbling and hence an increase in mass transfer resistance.

In operation it is preferred if the porous support layer is adjacent the gas flow and the non-porous membrane is adjacent the solvent.

It is preferred if the selectivity of the dense membrane for CO₂ is at least 100 times greater than solvent selectivity, such as at least 500 times greater.

### Process

The processes of the invention are used to separate CO₂ from a mixed gaseous feed stream.

In all embodiments, it is preferred if the process of the invention results in the capture of at least 80%, more preferably at least 85%, even more preferably at least 90%, such as at least 95%, e.g. at least 99% of CO₂ present in the original gaseous feed stream.

The gaseous feed stream, after contact with the membrane, typically comprises less than 10 vol %, preferably less than 5 vol %, more preferably less than 2 vol %, such as less than 1 vol % of CO₂ relative to the total amount of gas present.

Solvent and gas can be forced in counter current flow to maximise operation.

The invention will now be described with reference to the following non limiting examples and figures.

### DESCRIPTION OF FIGURES

FIG. 1. Illustrates the process of the invention. Flue gas enters composite membrane unit (1) via a conduit (2). It can enter the unit (1) under pressure generated by fan (10). Flue gas passes through the unit (1) from bottom to top as shown. Carbon dioxide is transported across composite membrane (3), into the solvent on the permeate side of the membrane. Lean solvent enters via inlet (11) and rich solvent is removed via outlet (12). Purified gas can then be collected from outlet (4). Solvent and gas are forced in counter current flow. Heat exchange (5) is used to ensure that the solvent is piped to the unit (1) at a desired temperature. Rich solvent that has absorbed CO₂ can be passed back to the heat exchange (5) and moved to stripper (6) where CO₂ is separated from the solvent via heating. CO₂ is removed from the top of the stripper via condenser (7) and captured. Lean solvent is removed through the bottom of the stripper for recycling either to the stripper via reboiler (8) or back to heat exchanger (5) for recycling into the separation unit (1).

FIGS. 2 to 4 show the results of the immersion experiments of the examples showing compatibility between polymer materials and the solvents of primary interest in the invention.

FIG. 5 is a theoretical scheme of the composite membrane of the invention in operation. The gas feed stream containing carbon dioxide passes in a first direction and liquid phase, i.e. solvent, passes in a counter direction. Carbon dioxide passes from the gas stream through the porous layer and then dense membrane layer to the solvent. Solvent however cannot pass through the dense layer.

FIG. 6 shows the CO₂ permeability data for free standing films of Teflon AF2400 and AF1600.

FIG. 7 shows the comparison between the fluxes obtained through a Teflon AF2400 (thickness 53 μm) for CO₂, H₂O, DEEA and MAPA. In particular the CO₂ flux has been scaled on the real process conditions (flue gas pressure 1 bar, 13 vol % CO2), whereas the flux for the vapors have been obtained exposing the upstream side of the membrane to the pure liquids.

FIG. 8 shows the ideal selectivity (Hp: flux of amines scaled linearly with their molar concentration in the aqueous solution) achievable by using a Teflon AF2400 dense membrane based on the results reported in FIG. 11. Different concentrations of amines have been considered (e.g. xDyM=xM DEEA yM MAPA).

FIG. 9 shows the comparison between the fluxes obtained through a Teflon AF1600 (thickness 41 μm) for CO₂, H₂O, DEEA and MAPA. In particular the CO₂ flux has been scaled on the real process conditions (flue gas pressure 1 bar, 13 vol % CO₂), whereas the flux for the vapors have been obtained exposing the upstream side of the membrane to the pure liquids.

FIG. 10 reports the selectivity which can be ideally achieved by Teflon AF1600 in the real process conditions for different amines concentrations. The same assumptions mentioned for FIG. 8 apply.

FIG. 11 reports SEM picture of the composite hollow fibers membrane obtained by coating Teflon AF2400 on a commercial porous polypropylene hollow fiber. Fluorinert FC72 produced by 3M has been used as a solvent for the fluorine-based copolymer.

FIGS. 12 to 14 summarise the carbon dioxide capacity per cycle for blends of MAPA with various solvents.

FIGS. 15a and b show the effect of adding 7.5 wt % ZIF8 to the Teflon AF2400 polymeric matrix on the amines (DEEA and MAPA) flux through a 10 μm thick membrane. It is clear that the addition of nanoparticles is able to reduce the amine flux, due to the sieving mechanism of the ZIF-8 nanoparticles. Indeed, they have a pore size that allows CO2 permeation but prevent the permeation of larger penetrants, such as the DEEA and MAPA. In addition, larger permeability fluxes compared to the pure AF2400 have been obtained: permeability as high as 4200 Barrer has been achieved in case of AF2400+ZIF8 membrane, which represents a significant enhancement compared to the permeability of the pure polymeric phase (about 3000 Barrer).

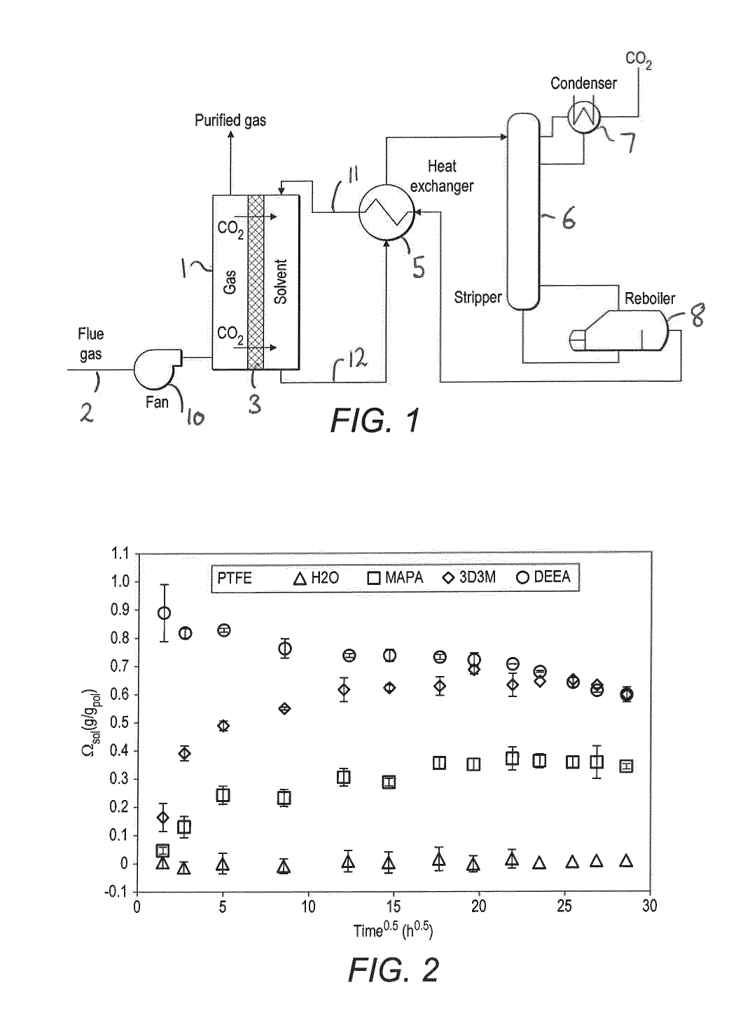

### EXAMPLES

Immersion tests

Different materials have been immersed in H₂O, DEEA, MAPA and an aqueous mixture of 3M DEEA, 3M MAPA (hereinafter refereed as 3D3M) and stored at 60° C. The uptake of solvent was compared for each material.

### PTFE

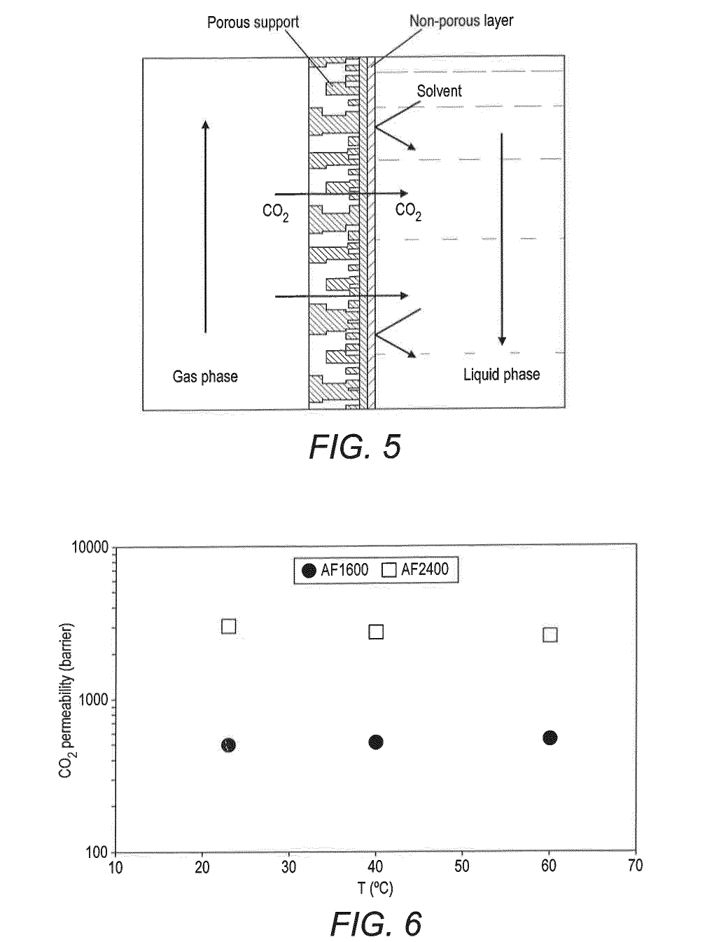

The PTFE (ePTFE, Gore, Porous) was initially immersed as a composite membrane (porous PTFE+porous Polyester as support layer) but the polyester was easily dissolved by the pure amines and the 3D3M solution. Thus, the test was repeated using only the porous PTFE layer. As expected the material showed a high hydrophobic behavior (negligible water uptake), but also a high affinity with the amine, especially DEEA. In case of MAPA the uptake kinetics resulted to be much slower, affecting the behavior of the mixture as well. Results are shown in FIG. 5. However, after 5 weeks of immersion, the samples appeared to show a good compatibility with the absorbent solutions. The retrievement of the initial weight of the samples after the monitoring campaign have been obtained within an error of 3%.

### Polypropylene

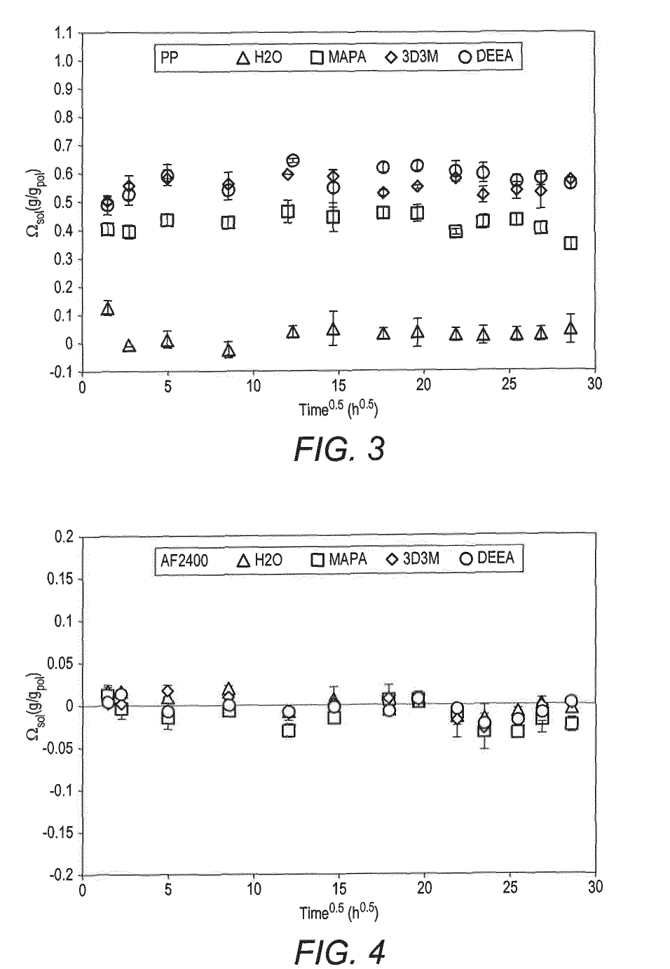

The Polypropylene (Celgard 2400, porous) also showed hydrophobic character as expected. In addition, the amines uptake was relatively high, leading to a 3D3M solution uptake of about 0.6 g/gpol. However, no sign of relevant swelling has been observed over time, since the uptake remained stable over the entire monitoring campaign. Results are shown in FIG. 3. Furthermore, after 5 weeks of immersion the initial weight was retrieved with an error always below 6%, suggesting a good compatibility with the considered solvents.

### Teflon AF2400

The Teflon AF2400 (DuPont, dense) showed the very good performance. Indeed, a negligible uptake has been observed for all the different solutions and no macroscopic changes have been detected on the immersed samples after 5 weeks, suggesting also that the material is able to ensure certain selectivity between CO₂ and the absorbent solution. Results are shown in FIG. 4. Good compatibility has been observed as well, since the initial weight was retrieve within an error of 3%.

### Permeability Tests

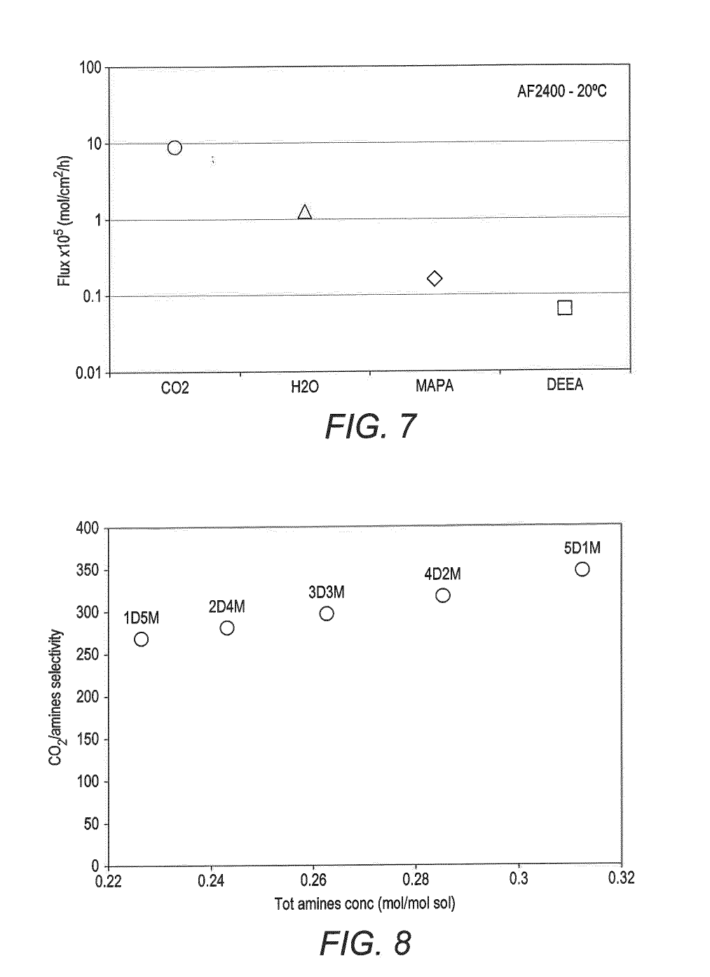

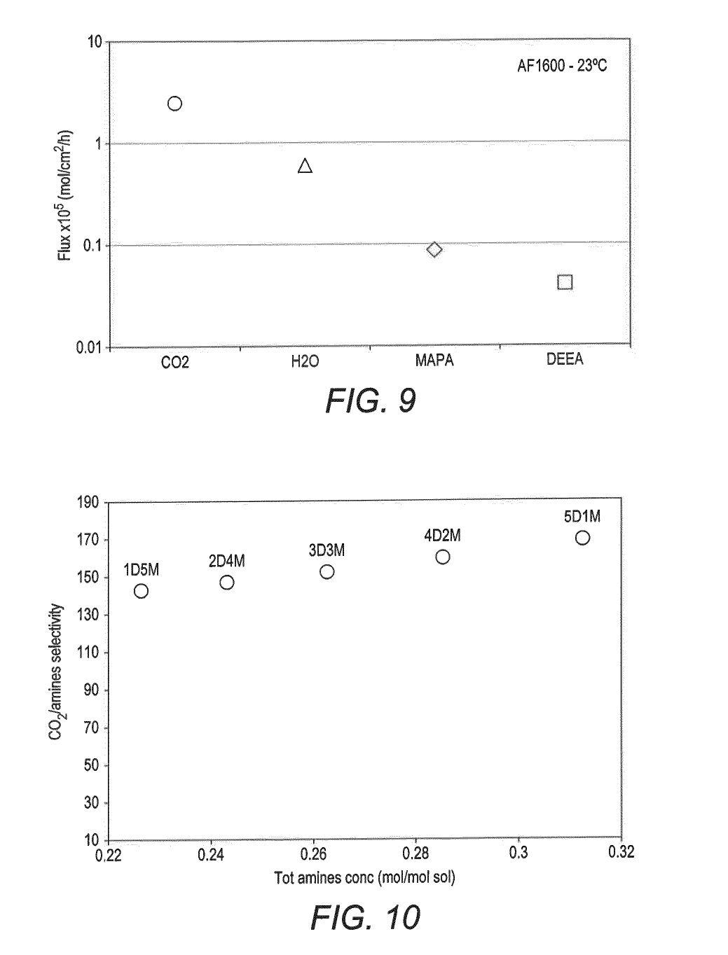

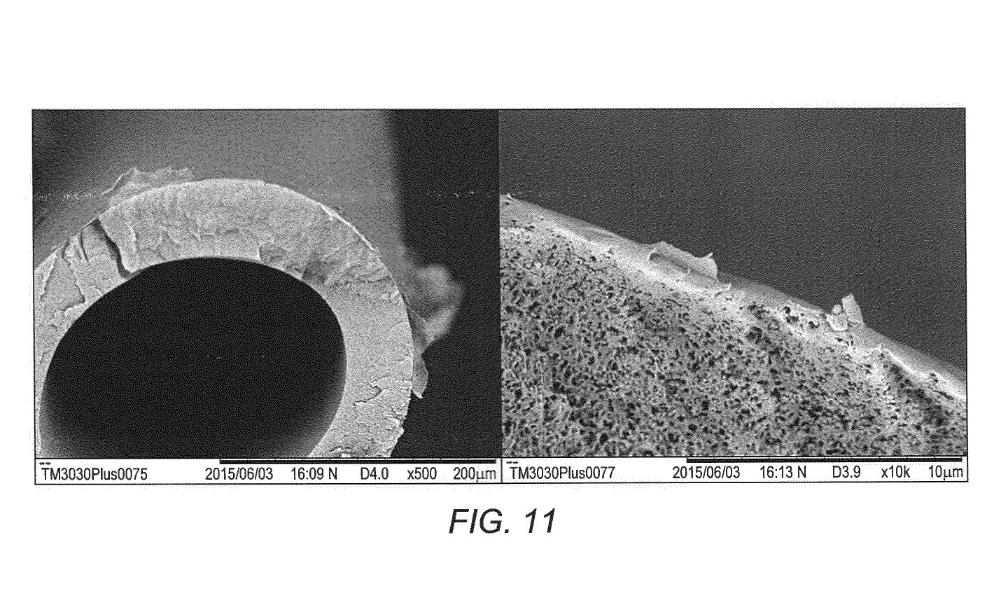

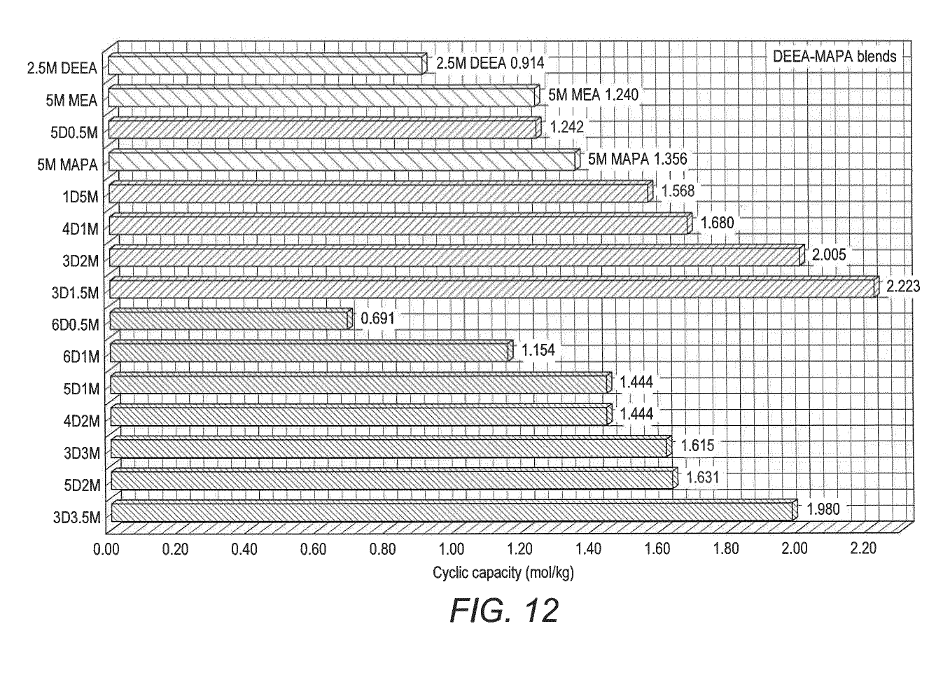

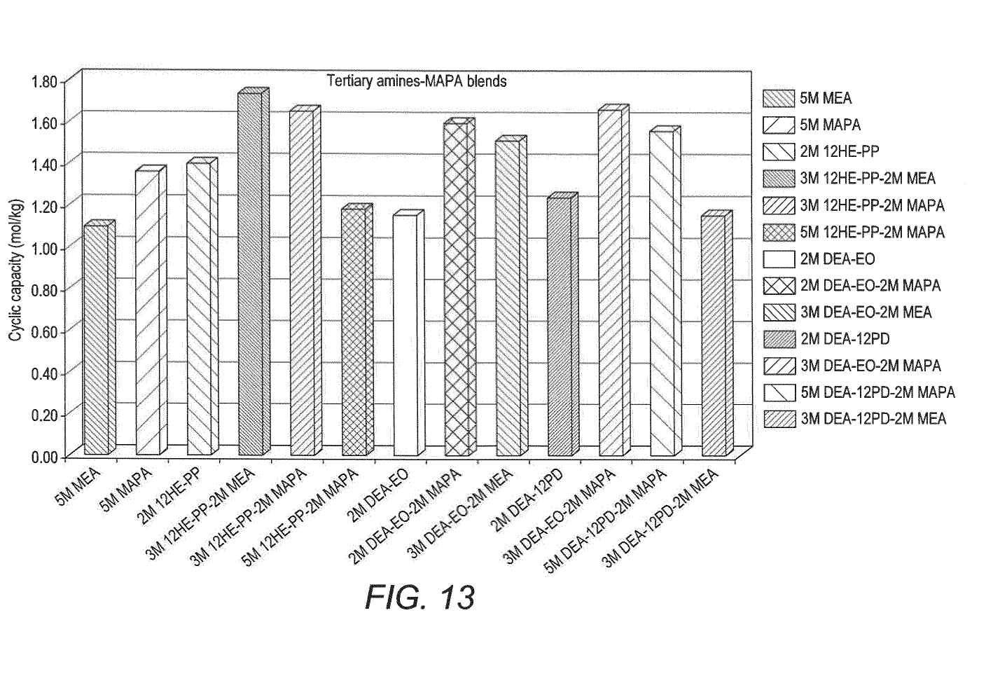

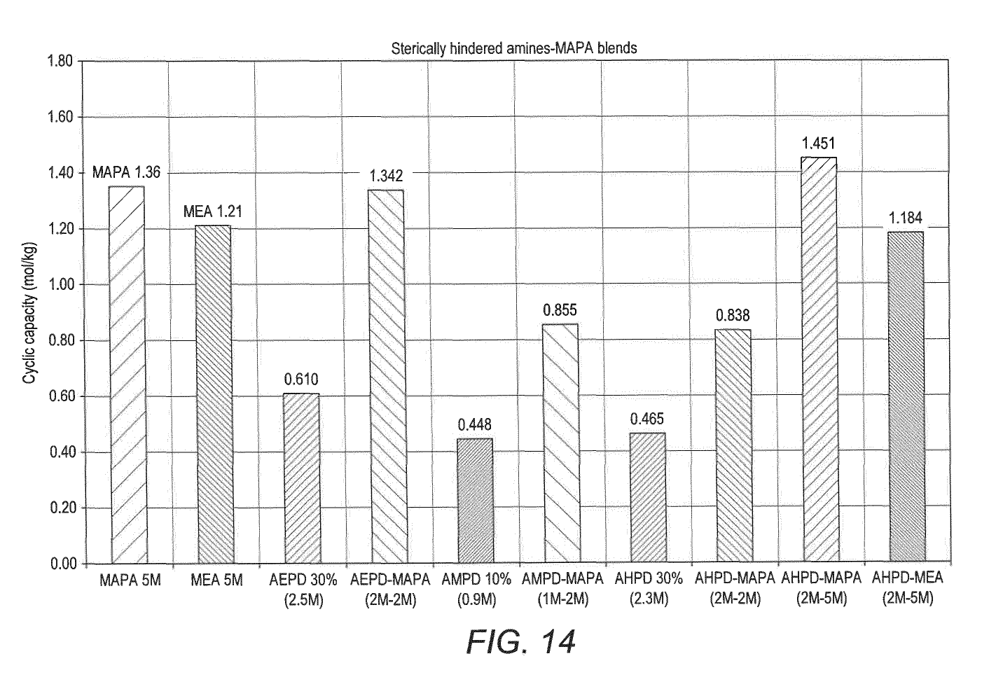

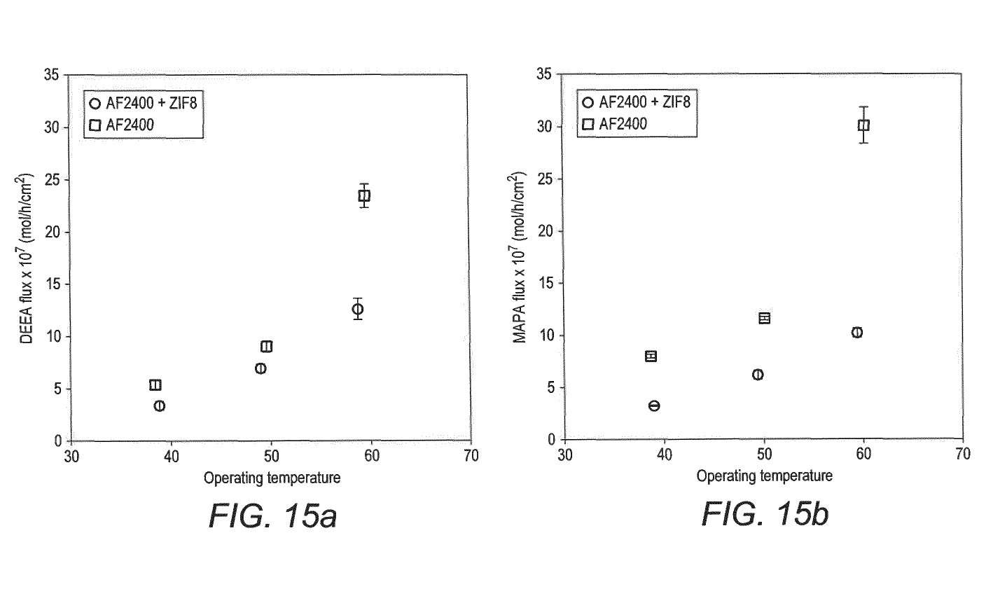

Pure gas permeability tests at different operative temperature and approximately 1.5 bar as upstream side pressure have been performed using a pure gas permeation apparatus. At 23° C. the permeability of Teflon AF2400 is about 3000 Barrer and it decreases at higher operative temperatures, although the temperature influence on this parameter is rather small (activation energy for permeation is −3.84 kJ/mol). In case of Teflon AF1600 the permeability is smaller, due to the larger amount of PTFE monomers in the polymer chain and corresponds to 500 Barrer at room temperature operating conditions. However, the operative temperature has an opposite effect on the polymer transport properties, being the activation energy of the permeation process calculated as equal to 1.68 kJ/mol. Permeation tests of the pure liquids which are part of the third generation solvent considered as reference (H₂O, DEEA and MAPA) have been carried out on thick films of the considered polymers (AF2400 and AF1600). In FIG. 7 the results obtained for a 53 μm thick Teflon AF2400 membrane are shown. In particular the figure reports the transmembrane flux obtained for the pure chemicals (CO₂, H₂O, DEEA and MAPA): in case of CO₂ the flux value is already scaled on the real process conditions (flue gas pressure 1 bar and 13 vol % CO₂ in the stream), whereas the vapors flux are the ones obtained exposing the upstream side of the membrane to the pure liquids. Based on these data and assuming that the amine flux scales linearly with their molar concentration in the aqueous solution, the selectivities achievable by Teflon AF2400 have been calculated for different amine concentrations in the third generation solvents at room temperature conditions (FIG. 8), resulting to be always larger than 250. In case of Teflon AF1600 (FIG. 9, membrane thickness 41 μm) lower fluxes have been achieve despite the smaller thickness compared to the AF2400 sample, likely due to the lower free volume of the polymer matrix. The flux values obtained have been used also for the calculation of the ideal selectivity which can be achieved in the real conditions of the permeation process (same assumptions considered for the AF2400 grade apply) and in this case slightly lower selectivity has been achieved, which varies between 140 and 170 in the considered concentration range of amines.

### Composite Membranes

A proper procedure to obtain a composite membrane with a thin dense layer of Teflon AF2400 has been identified. In view of the good compatibility showed, porous polypropylene (PP) has been chosen as support layer. The Teflon AF2400 has been coated on porous polypropylene hollow fibers (Membrana Oxyphan, Type PP 50/200), based a literature procedure. The obtained results are reported in FIG. 10.

1. A membrane contactor system for separating CO₂ from a mixed gaseous feed stream comprising CO₂, said contactor system comprising:
(i) a composite membrane, said membrane having a permeate side and a retentate side;
(ii) said retentate side being exposed to a mixed gaseous feed stream comprising carbon dioxide;
(iii) said permeate side being exposed to a carbon dioxide capture organic solvent;
(iv) said composite membrane comprising a porous layer and a non-porous selective polymer layer, said non-porous selective polymer layer selectively allowing transport of CO₂ across the composite membrane from said mixed gaseous feed stream so that it dissolves in said capture solvent whilst limiting the transport of said capture solvent across the composite membrane.

2. The system as claimed in claim 1, wherein the porous layer is nearest the retentate side of the composite membrane and the non-porous selective polymer layer is nearest the permeate side of the composite membrane.

3. The system as claimed in claim 1, wherein the polymer of the non-porous selective polymer layer comprises the residue of a fluorocarbon monomer.

4. The system as claimed in claim 1, wherein the polymer of the non-porous selective polymer layer is a copolymer.

5. The system as claimed in claim 4, wherein the copolymer comprises monomer residues of fluorinated monomers.

6. The system as claimed in claim 1, wherein the polymer of the non-porous selective polymer layer is chemically compatible with an amine-based organic capture solvent.

7. The system as claimed in claim 1, wherein the non-porous selective polymer layer has a selectivity towards CO₂ over capture solvent of larger than 100 times.

8. The system as claimed in claim 1, wherein the non-porous selective polymer layer is less than 5 microns in thickness.

9. The system as claimed in claim 1, wherein the porous layer is a polypropylene or PTFE.

10. The system as claimed in claim 1, wherein the porous layer has an MWCO of 25,000 or more.

11. The system as claimed in claim 1, wherein the organic capture solvent comprises an amine.

12. The system as claimed in claim 1, wherein the organic capture solvent has a Mw of 300 g/mol or less and consists of the atoms N, H, C and optionally O.

13. The system as claimed in claim 1, wherein the organic capture solvent comprises: diethylethanolamine (DEEA), N-methyl-1,3-propane diamine (MAPA), highly concentrated monoethanolamine (MEA), 2-amino-2-methyl-1-propanol (AMP), 2-dimethylaminoethanol (DMMEA), modified imidazoles, 1-(2-hydroxyethyl)piperidine (12HE-PP), 3-(diethylamino)-1,2-propanediol (DEA-12PD), 2-[2-(diethylamino)ethoxy]ethanol (DEA-EO), 2-Amino-2-methyl-1,3-propanediol (AMPD), 2-amino-2-hydroxymethyl-1,3-propanediol (AHPD), or 2-Amino-2-ethyl-1,3-propanediol (AEPD).

14. The system as claimed in claim 1, wherein the organic capture solvent comprises a mixture of at least two amine-based solvents.

15. The system as claimed in any preceding claim 1, wherein the organic capture solvent comprises a mixture of an organic base and an amine, a combination of amines or an amine functionalized ionic liquid.

16. The system as claimed in claim 1, wherein the organic capture solvent is a mixture that undergoes demixing when mixed with CO₂.

17. The system as claimed in claim 1, wherein the organic capture solvent comprises a blend of a primary amine and a secondary or tertiary amine.

18. The system as claimed in claim 1, wherein the solvent is a blend of N-methyl-1,3-propane diamine (MAPA) and diethylethanolamine (DEEA).

19. The system as claimed in claim 1, wherein the composite membrane is in the form of a hollow fiber membrane.

20. The system as claimed in claim 1, wherein the non-porous selective polymer layer comprises a polymer and an inorganic component.

21. The system as claimed in claim 20, wherein the inorganic component comprises a nanoparticle such as a zeolite, MOF or is a nanostructure comprising graphene or derivative thereof.

22. A process for separating CO₂ from a mixed gaseous feed stream containing CO₂, said process comprising contacting said mixed gaseous feed stream with a composite membrane comprising a non-porous, selective polymer layer for separating CO₂ from a mixed gaseous feed stream, said layer being carried on a porous support layer:
allowing CO₂ to pass through said porous support layer and said non-porous selective polymer layer to make contact with an organic capture solvent which dissolves said CO₂; wherein
said non porous, selective polymer layer is impermeable or of limited permeability to said capture solvent.

23. The process as claimed in claim 22 wherein the gas stream is flue gas, biogas, natural gas, or syngas.

24. The process as claimed in claim 22, wherein the solvent and gas stream are at a temperature of less than 100° C.

25. The process as claimed in claim 22, wherein the gaseous feed stream is supplied at a pressure of less than 5 bars.
